(19) United States
(12) Patent Application Publication
(10) Pub. No.: US 2001/0025270 A1
(43) Pub. Date: Sep. 27, 2001

(54) Image searching and viewing system

(75) Inventors: Hiromichi Enomoto, Tokyo (JP); Yusuke Habu, Tokyo (JP)

Correspondence Address: FRISHAUF, HOLTZ, GOODMAN &, LANGER & CHICK, PC, 767 THIRD AVENUE, 25TH AVE, NEW YORK, NY, 10017-2023, US

(73) Assignee: Konica Corporation, Tokyo (JP)

(21) Appl. No.: 09/803,525

(22) Filed: Mar. 9, 2001

(30) Foreign Application Priority Data
Mar. 15, 2000 (JP) 071959/2000

(51) Int. Cl. G06F 17/60

(52) U.S. Cl. 705/52

(57) ABSTRACT

A data processing system, comprises a software having a function to process data; a storage medium storing image data and data needed for retrieving; and a processor to access both of the software and the storage medium so as to conduct processing the data in the storage medium based on the software.

### BACKGROUND OF THE INVENTION

The present invention relates to a technology to conduct data processing, for example, such as viewing an image according to the stored image data.

It is commonly conducted that an image is converted into the image data by a digital still camera or scanner, and is stored in a storage medium such as a CD-R. In this connection, recently, the increase of storage capacity advances, and, for example, in the storage medium such as a DVD, it comes to be realized that the image data can be stored in a unit of giga. Accordingly, in a sheet of such the storage medium, great many numbers of images can be stored in a predetermined format.

In this connection, in a data processing apparatus to display or print the image according to the image data stored in the storage medium such as a DVD, the technological innovation is further striking, and the data processing software is made version-up in a short cycle, and the model change of the product is made in a short cycle, and a platform on which the data processing software operates is also various. For such the change of the data processing software, up to now, the software provider is required to store again the image data to be processed and the data necessary for the processing, together with the data processing software. Specifically, when the amount of processing image data is great, it takes a considerable time.

For such the advancement of the data processing apparatus, it is considered that the image data can not be read from the storage medium in which the image data is stored in a old format. Accordingly, a person who desires to process the data according to the image data stored in such the storage medium, is required to do an additional operation in which the original image data is changed to a new format in which the data processing apparatus can read, by using an exclusive use software, or the original image data is converted and newly stored in a new storage medium, and sometimes it takes a considerable time.

On the one hand, it is also considered that the data processing service such as an image print order is conducted through the network such as the internet. Such the service is provided through an device such as a personal computer connected to the internet or the like, and there is an advantage that, thereby, the customer can receive the service while he is in his home or office.

However, from the reason that a cost of the personal computer is comparatively high, all of customers desiring to receive the data processing service can not always use it. In contrast to this, there is the real situation in which a television almost always provided in each family can be used as a display for displaying the image. Further, there is also the real situation that the domestic electric devices which are provided with high performance CPUs and can be connected to the network (for example, a domestic game machine), come to each home. However, for example, in the domestic game machine, because the protection mechanism by which the access to only the specific storage medium is allowed, but the use of the unfair software is inhibited, is provided, there is a problem that it is difficult to use this machine as it is in place of the personal computer.

Further, it is convenient when, in great amount of images stored in the storage medium, a specific image can be efficiently searched. However, a clear key word provided for the image data when the image data are written is necessary for the search of the image data, but, there is a problem that, when the memory is not clear, even a key word can not be cleared.

### SUMMARY OF THE INVENTION

In view of the foregoing problems, an object of the present invention is to provide a data processing system and an image searching and viewing system (an image retrieving viewing system) by which the operability of the user is increased by the data processing such as the searching (retrieving) and viewing (perusing) of the image according to the stored image data, in a more easily usable form.

The data processing system of the first aspect of the present invention is characterized in that, by making access to both of a software having a function to process the data in a data base and a storage medium in which the image data and the data necessary for searching are stored, the data processing in the data base is conducted.

The data processing system of the second aspect of the present invention is characterized in that, by making access to both of the first storage medium in which the information necessary for acquiring the software is stored, and the second storage medium in which the data necessary for the processing is stored, the data processing in the data base is conducted.

The data processing system of the third aspect of the present invention is characterized in that, by making access to both of the first storage medium in which the software having the function to process the data in the data base is stored, and the second storage medium in which the data necessary for the processing is stored, the processing of the data in the data base is conducted.

The data processing system of the fourth aspect of the present invention is characterized in that, by making access to the read-only storage medium in which the first protection key is stored, and the writable storage medium in which at least image data is stored, the image data is processed.

An image searching and viewing system of the fifth aspect of the present invention has the first display apparatus to mainly display the image content, the second display means to mainly display the information relating to the image content, and an external server connected to the first display apparatus and the second display apparatus, the image searching and viewing system is characterized in that: the information relating to the image content displayed by the second display apparatus is changed corresponding to the operation of the first display apparatus.

An service system of the sixth aspect of the present invention is characterized in that, in the service system having a terminal equipment connected to the network and the external server, and receiving the data processing service through the network, a unique ID cord is stored in the local storage apparatus connectable to the terminal equipment, and the ID cord is transmitted corresponding to the use of the service of the user, and the account information corresponding to the ID cord in the external server is changed.

According to the data processing apparatus of the first aspect of the present invention, because, by making access to both of the software having a function to process the data in the data base and the storage medium in which the image data and the data necessary for searching are stored, the data processing in the data base is conducted, for example, even in the case where it is necessary to change the software for the data processing, only the software can be made upgrade, and because, even in this case, the storage medium can be used as it is, the image data can be stored in the storage medium for a long period of time, and further, because the image data can be read out at any time, this apparatus is convenient. Further, because the image data and the searching data are stored in the same storage medium, the processing can be effectively conducted.

According to the data processing apparatus of the second aspect of the present invention, because, by making access to both of the first storage medium in which the information necessary for acquiring the software is stored, and the second storage medium in which the data necessary for the processing is stored, the data processing in the data base is conducted, for example, even in the case where it is necessary to change the software for the data processing, because the software can be acquired according to the information of the first storage medium, the upgrade of the software can be made easily, and because, even in this case, the second storage medium can be used as it is, the image data can be stored in the second storage medium for a long period of time, and further, because the image data can be read out at any time, this apparatus is convenient. In this connection, when the software has a function to process the data in the data base, it is preferable, but the invention is not limited to this.

Further, when the information necessary for acquiring the software includes a URL of a download center and the identification information of the first storage medium, because the software can be downloaded through the network such as the internet and can be stored in the local storage medium, this apparatus is convenient.

Further, when the software is downloaded in the storage medium through the network, it is preferable.

Further, when the cost of the first storage medium is different corresponding to the cost of the software, the adequate charge for using the software can be charged on the user.

Further, when the first storage medium is used as a prepaid card, because the charge for using the software can be previously paid, it is convenient.

Further, when the charge is accounted online corresponding to the cost of the software, because the time and trouble of the payment of the charge and collection of the charge can be saved, it is convenient.

According to the data processing system of the third aspect of the present invention, because, by making access to both of the first storage medium in which the software having the function to process the data in the data base is stored, and the second storage medium in which the data necessary for the processing is stored, the processing of the data in the data base is conducted, for example, even in the case where it is necessary to change the software for the data processing, only by replacing only the first storage medium with the new one, the software can be easily made upgrade, and because, even in this case, the second storage medium can be used as it is, the image data can be stored in the second storage medium for a long period of time, and further, because the image data can be read out at any time, this system is convenient.

Further, when the software has a function to register, view, search, process, print or conduct the print order for a plurality of images through the internet, and the data is the image data or the data necessary for the search, because the view of the image or the print of the image can be easily conducted by using the data processing system, it is convenient. Herein, “the data necessary for the search” includes, for example, the date or time at which the image is acquired, the name of the acquisitor, the place at which the image is acquired, or color and the data expressing the features of the image such as the complexity, however, the present invention is not limited to that.

Further, when the second storage medium in which the data necessary for the processing is stored is writable, for example, such as a CD-RW, the image data can be successively accumulated, and when the first storage medium in which the software is stored is read-only, for example, such as a CD-ROM, it is preferable for handling.

Further, when the second storage medium in which the image data and the data necessary for the search are stored, is made in a lab or mini-lab, it is not necessary that the customer possesses the exclusive use apparatus to store these data, and the burden of the customer can be reduced.

Further, in the case where the image data and the data necessary for the search are written in the second storage medium, when the image data is written after the data necessary for the search is written, even when it occurs that there is no space capacity in the storage medium, because the data necessary for the search is stored before the image data, the number of times to replace the disk is reduced, and the search processing can be quickly conducted.

Further, in the case where the image data and the data necessary for the search are stored in a plurality of the second storage media, when the thumbnail data of the image stored in the second storage medium, in which the data is previously written, and the data necessary for the search are stored in the second storage medium in which the data is written later, in the case where only the second storage medium which is the last one in the time series is used, because the image data stored in the second storage medium can be read out, the search, view, and processing of the image are easily conducted.

Further, in the case where the only the storage medium in which the image data is stored later, is used and the processing of the original image stored in the different second storage medium is conducted, when the processing is conducted by using the thumbnail data, it is not necessary to replace the storage medium, and the trouble of the processing is saved.

According to the data processing system of the fourth aspect of the present invention, because, by making access to both of the read-only storage medium in which the first protection key is stored, and the writable storage medium in which at least image data is stored, the image data is processed, for example, in the data processing apparatus such as a domestic game machine, in the case where the protection function to inhibit to make access to the not allowed storage medium is provided, initially by making access to the read-only storage medium in which the first protection key is stored, the protection function is released, and next, by making access to the writable storage medium, when the stored image data is read out, the data processing can be conducted without relying upon the personal computers.

Further, in the case where, in both of the read-only sotrage medium and the writable storage medium, the second protection key relating to each other is stored, and the first protection key and the second protection key coincide with each other, when the data processing can be conducted for the first time by the data processing apparatus such as the domestic game machine, because the stronger protection function is secured, it is preferable.

Further, when the global service information is stored in the read-only storage medium, and the local service information is stored in the writable storage medium, an allotment of the information can be conducted, and even when the global service information is changed regularly or irregularly, because only the read-only storage medium may be replaced, and the writable storage medium in which the local serve information is stored, can be continuously used as it is, it is convenient. Herein, the [global service information] means, for example, the service information not depending on the local area, including the URL of the service center by which the data processing can be conducted in the large size, an address to make contact, business date, and the industrial advertisement information, etc., and the [local service information] means the individual information, including the information of the local area near one's house, URL of the lab near one's house, address to make contact, serial number, pre-paid service information according to the serial number, etc., but, the invention is not limited to them.

Further, when the first protection key is written in an exclusive use position in the read-only storage medium which only a specific data processing apparatus can read or write, because it is difficult that the first protection key is unfairly obtained, or unfairly duplicated, it is preferable.

Further, when the second protection key is written in an exclusive use position in the writable storage medium which only a specific data processing apparatus can read or write, because it is difficult that the first protection key is unfairly obtained, or unfairly duplicated, it is preferable.

Further, when one or both of the first protection key and the second protection key is written in an exclusive use position in the read-only storage medium which only a specific data processing apparatus can read or write, because it is difficult that the first protection key and the second protection key are unfairly obtained, or unfairly duplicated, it is preferable.

When an execution file is stored only in the read-only storage medium, the unfair use of the read-only storage medium can be suppressed.

According to the image searching and viewing system of the fifth aspect of the present invention, it has the first display apparatus to mainly display the image content, the second display means to mainly display the information relating to the image content, and an external server connected to the first display apparatus and the second display apparatus, and the information relating to the image content displayed by the second display apparatus is changed corresponding to the operation of the first display apparatus. Herein, the [image content] means the image data included in the data base.

Herein, when a specific image is searched from the large amount of image data, there is a case where only an indefinite memory exists for the image. Accordingly, there is a problem that it takes a considerable time to select a specific image from a large amount of image data. For this problem, according to the present invention, even when it is an indefinite memory, a clue to specify the image can be given.

For example, when the specific image is searched, and it is wanted to display the image on the first display apparatus, it is considered that the search information is inputted into the first display apparatus by operating the apparatus. In this case, when there is the indefinite memory that it is an image acquired about 10 years before, this information can be used as the search information. That is, when the key word of ‘2nd year of Heisei’ is inputted as the search information, this key word is transmitted to the external server, and the events or happenings which have occurred in 2nd year of Heisei are searched, and the information relating to them are displayed on the second display apparatus. That is, corresponding to the operation of the first display apparatus, the information relating to the image content displayed on the second display apparatus is changed. The operator views the events or happenings displayed on the second display apparatus, and by using them as a clue, he can check whether there are events or happenings which have occurred in a time period closest to the image acquisition. When there are such events or happenings, the image acquired before or after the date in which events or happenings have occurred, is searched, and the specific image can be found.

Further, according to the present invention, the following service can be conducted. In the case where a specific image is confirmed, when this is displayed on the first display apparatus, the data relating to the date and the content is transmitted to the external server, and the information relating to the events or happenings which have occurred before and after the date, or the information relating to events or happenings relating to the content is displayed on the second display apparatus. The operator can conduct the image composition processing such as the addition of characters, on the image displayed on the first display apparatus, by using these events or happenings.

The first display apparatus and the second display apparatus may also be connected to each other through the internet or local area network.

Further, it is preferable when the image content is displayed on the first display apparatus, according to the image data stored in the local storage apparatus connected to the first display apparatus. In this connection, the [local storage apparatus] means the hard disk, server, pick up apparatus to store the information in the storage medium such as the CD or DVD, etc., but, the apparatus is not limited to them.

Further, in the first display apparatus mainly displaying the image content, when the image information stored in the external server is displayed according to the image content and the switch information stored in the local storage apparatus, because the image information is automatically displayed, it is preferable. Herein, the [switch information] includes the information to display or not, the image information, or the information for instructing to display which information.

Further, it is preferable when the image information includes the information relating to any one of a notice, advertisement, the image at the time near the photographing date of the image, and landscape or accident image near the image content, or a combination of them.

Further, when the display of the information stored in the external server is inhibited according to the switch information stored in the local storage apparatus, because the transmission of the unnecessary information is prevented, it is preferable.

Further, when the information to be used for time-ranking the image displayed on the first display apparatus is displayed on the second display apparatus, the search can be more easily conducted, which is convenient.

Further, when the first display apparatus is a television, because it exists in almost family, the economical burden of the user can be suppressed in the case where the image searching and viewing system is used.

According to the service system of the sixth aspect of the present invention, because, in the service system having a terminal equipment connected to the network and the external server, and receiving the data processing service through the network, a unique ID cord is stored in the local storage medium connectable to the terminal equipment, and the ID cord is transmitted corresponding to the use of the service of the user, and the account information corresponding to the ID cord in the external server is changed, even when the user forgets the ID cord, or even when the user receives the data processing service by using another terminal equipment, because, by connecting the local storage apparatus to the terminal equipment, the ID cord unique to the user is transmitted to the external server, and the account information is automatically rewritten, the trouble of operation is saved, and it is convenient.

### BRIEF DESCRIPTION OF THE DRAWINGS

FIG. 1 is a block diagram showing a data processing apparatus according to the first embodiment.

FIGS. 2(a) to 2(d) each is a view showing a attachment condition of protection keys in media M1 and M2.

FIG. 3 is a view for explaining a view system according to the second embodiment.

### DETAILED DESCRIPTION OF THE PREFERRED EMBODIMENT

Referring to the drawings, embodiments of the present invention will be described below.

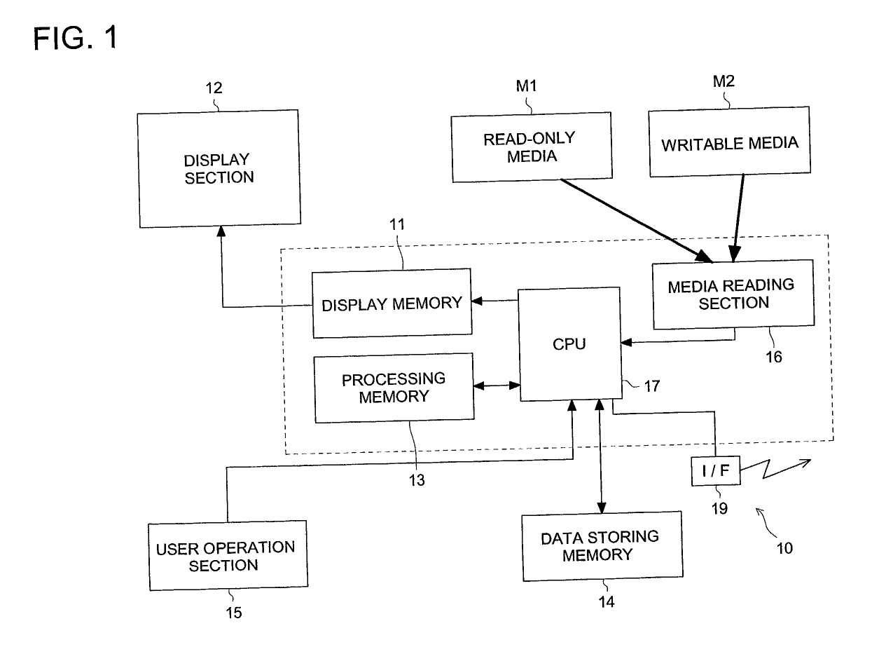

FIG. 1 is a block diagram showing a data processing apparatus according to the first embodiment. A data processing apparatus 10 has a display memory 11, display section 12 such as the display, processing memory 13, data storing memory 14, user operation section 15, media reading section 16 to make access to read-only media (storage medium) M1 and writable media M2, and to read out the stored data, and CPU 17 which is connected to them and which controls them. In this connection, when a domestic game machine is used as the data processing apparatus 10, a television can used as the display section 12.

Herein, in the read-only media (storage medium) M1 as the first storage medium, a program for the image search, view, processing (treatment) is stored, and in the writable media M2 as the second storage medium, the image data and the information relating to the image data (image photographing time, image photographing place, image features) are stored, in which a data base is structured.

When the user wants to search and view the image, initially, the media reading section 16 of the data processing apparatus 10 is made to read the program for the image search, view, processing (treatment)in the read-only media M1, and stores it in the data storing memory 14. Then, by the operation of the user operation section 15, the program is executed, and according to the information (image photographing time, image photographing place, image features) relating to the image data in the writable media M2, the user can search the stored image data. The searched image data is stored in the display memory 11, and according to it, the image is displayed on the display section 12, or the processing such as the image composition is conducted by using the processing memory 13.

According to the data processing system of the present embodiment, by making access to both of the media M1 in which the program having the function to process (search, view, processing) the data in the data base is stored, and the second media M2 in which the data necessary for the processing is stored, because the processing of the data in the data base is conducted, for example, even when it is necessary that the data processing program is changed, only by replacing only the media M1 with new one, the upgrade of the program can be easily conducted, and also in such the case, because the media M2 can be used as it is, the image data can be stored in the media M2 for a long period of time, and because the image data can be read out at any time, it is convenient.

Further, the program stored in the media M1 has a function which can register, view, search, and process a plurality of images, however, it can also be considered that, according to another function of such the program, for example, the data processing apparatus 10 is connected to a printer (not shown) through an interface 19, and the image is printed, or a print order is conducted to a lab through a network such as an internet.

Further, when the media M2 is a writable DVD-RAM or the like, the image data can be successively accumulated, and on the one hand, when the media M1 is a read-only DVD-ROM, because the unfair rewriting of the program can be prevented, it is preferable.

Further, a service in which, in the lab or mini-lab, the negative image is digitized (made into the image data) by a film scanner, and the image and the information necessary for the search are stored in the second storage medium (media M2), can be considered. When such the service is used, normally, when the original image data having a large amount of image information of 10-12 bits before it is converted into 8 bits and stored, is used, because the information necessary for the search can be effectively extracted, there is an effect that the accuracy of the search is increased. Herein, the information necessary for the search shows, for example, the histogram or complexity relating to the color. By storing such the information, the similar image can be automatically searched from the features of the image without adding the key word.

Further, in the case where the image data and the data necessary for the search are written in the media M2, when the image data is written after the data necessary for the search is written, because the data necessary for the search can be quickly read out, it is preferable.

Further, in the case where the image data and the data necessary for the search are stored in a plurality of media M2, when the thumbnail data of the image stored in the media M2, in which the data has been previously written, and the data necessary for the search are stored in the media M2 in which the image data and the data necessary for the search are written later, in the case where only the last media M2 in the time series, is used, apart from the size of the data, because the image data stored in all of the media M2 can be read out, the search, view, and processing of the image become easy.

Further, when, by using only the media M2 in which the image data is stored later, the original image data stored in the different media M2 is processed, even when it happens that there is no space capacity of the media when the image data is stored in the media, because the data necessary for the search is stored preceding the image data, the number of times to replace the disk, that is, media, is decreased, and the search processing can be quickly conducted.

In this connection, in some type of domestic game machines, in order to prevent the execution of the program which is not allowed, the protection key is attached in the media in which only the allowed program is stored. That is, when the media is loaded in such the domestic game machine, it is judged whether such the protection key is attached, and the program is not read-in from the media in which the protection key is not attached. Accordingly, when such type of domestic game machine is used as the data processing apparatus, the way of its use becomes a problem.

Accordingly, in the data processing system according to the present embodiment, by making access to both of the read-only media M1 in which the first protection key is stored, and the writable media 2 in which at least the image data is stored, the processing of the image data is conducted. When more specifically explained, in the data processing apparatus such as the domestic game machine, when the protection function to inhibit the making access to the not allowed media (herein, the media M2) is provided, initially, by making access the data processing apparatus to the read-only media M1 in which the first protection key is stored, which is the media to which making access is allowed, such the protection function is released, and when, by making access to the media M2, the stored image data is read out, the data processing such as the view and search of the image can be conducted without relying on the personal computer or the like. In this connection, when the execution file is stored only in the read-only media M1, because the unfair use of the read-only media M1 can be suppressed, it is preferable.

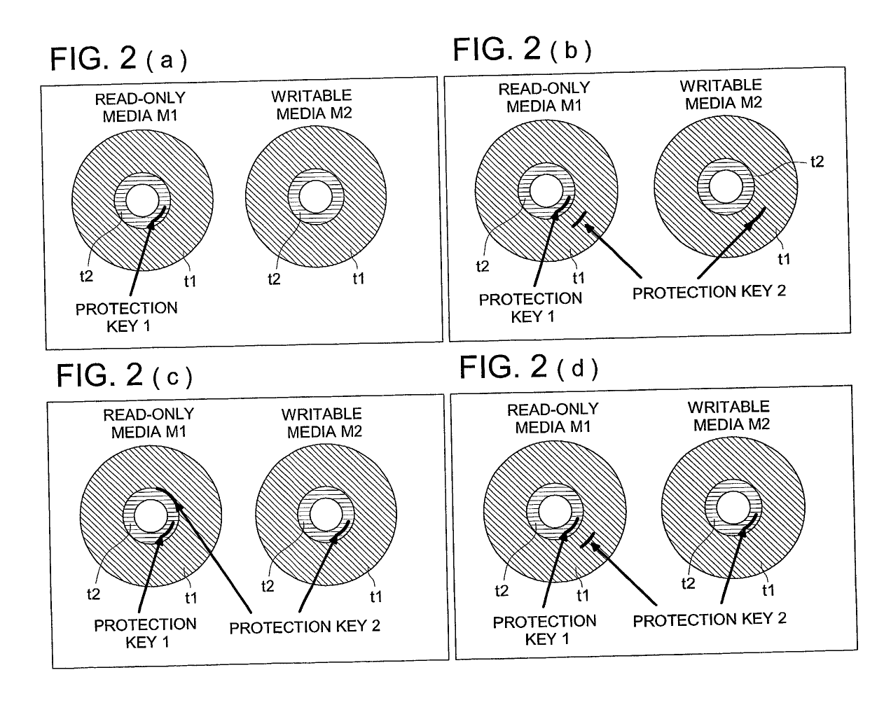

FIG. 2 is a view showing the attachment condition of the protection key in the media M1 and M2. The media M1 and M2, which are the disk type storage media such as DVD, have an area t1 in which the data can be read by the ordinary information reading device, and inside it, an area t2 in which the data can not be read by the ordinary information reading device. It is defined that the data processing apparatus 10 of the present embodiment can read the data in the area t2. According to the first mode shown in FIG. 2(a), the protection key (for example, the encrypted information, or the like) is stored in the area t2 of the media M1, and when the data processing apparatus 10 read this, for the first time, the data reading from the media M2 can be conducted.

Further, according to the second mode shown in FIG. 2(b), the first protection key (for example, the encrypted information, or the like) is stored in the area t2 of the media M1, and the second protection key is stored in the area t1, and on the one hand, the same second protection key is stored also in the area t1 of the media M2. Initially, the data processing apparatus 10 reads out the first and the second protection keys, and according to the first protection key, the data can be read-in from the media M2, and further, in the case where the second protection key is included in the data read out by the media M2, when the processing is made to be conducted at the first time, the execution of the not allowed program can be more effectively suppressed. In this connection, it is not always necessary that the second protection keys stored in the media M1 and M2 are the same, but after the data processing key 10 reads out the second protection key of the media M1, in the case where it reads out the second protection key of the media M2, when there is a relationship in which it can be judged that these keys correspond to each other, it is sufficient.

Further, according to the third mode shown in FIG. 2(c), the first and second protection keys (for example, the encrypted information, or the like) are stored in the area t2 of the media M1, and on the one hand, the second key is stored also in the area t2 of the media M2. In the same manner as in the second mode, the data processing apparatus 10 reads out the first and the second protection keys, and according to the first protection key, the data reading-in from the media M2 can be conducted, and further, in the case where the second protection key is included in the data read out by the media M2, when the processing is made to be conducted at the first time, the execution of the not allowed program can be more effectively suppressed.

Further, according to the second mode shown in FIG. 2(d), the first protection key (for example, the encrypted information, or the like) is stored in the area t2 of the media M1, and the second key is stored in its area t1, and on the one hand, the second key is stored in the area t2 of the media M2. Initially, the data processing apparatus 10 reads out the first and the second protection keys, and according to the first protection key, the data reading-in from the media M2 can be conducted, and further, in the case where the second protection key is included in the data read out by the media M2, when the processing is made to be conducted at the first time, the execution of the not allowed program can be more effectively suppressed.

In this connection, in the case where the global service information is stored in the read-only storage media M1, and the local service information is stored in the writable storage media M2, when the global service information is changed regularly or irregularly, because only the read-only storage media M1 may be replaced, and the writable storage media M2 in which the local serve information is stored, can be continuously used as it is, it is convenient.

In this connection, when the specific image is searched from a great amount of image data, there is a case where only an indefinite memory exists for such the image. Accordingly, in order to search the specific image form a great amount of image data, there is a problem that it takes a considerable time period. For this, according to the present embodiment which will be described below, a clue to specify the image even for the indefinite memory can be given.

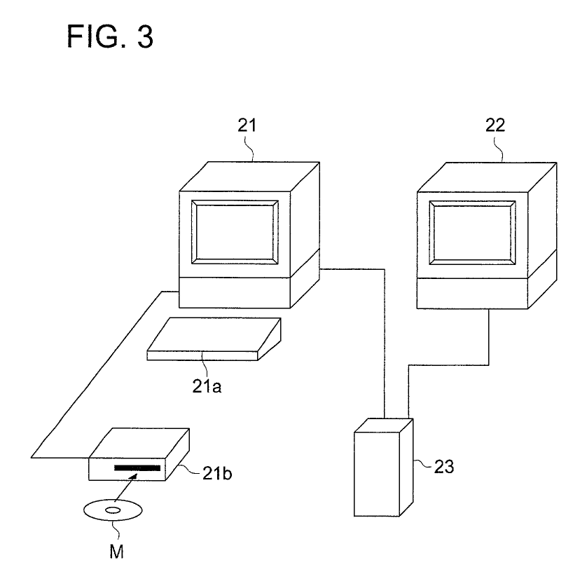

FIG. 3 is a view for explaining the view system of the second embodiment. In FIG. 3, the first display apparatus which has an operation section 21a and can connect to a media reading apparatus 21b, and the second display apparatus are connected to an external server 23 through the internet, or the like. When, for example, the user searches a specific image, and wants to display it on the first display apparatus 21 shown in FIG. 3, it is considered that the search information is inputted by operating the first display apparatus 21.

In this case, when the user has a memory that it is an image acquired about 10 years before, this information can be used as the search information. That is, when the key word of ‘2nd year of Heisei’ is inputted as the search information, this key word is transmitted to the external server 23, and the events or happenings which have occurred in 2nd year of Heisei are searched, and the information relating to them are displayed on the second display apparatus 22. These events and happenings are composed of a combination of the characters and images, and it is preferable when these are arranged in the time series.

The operator views the events or happenings displayed on the second display apparatus 22, and by using them as a clue, he can check whether there are events or happenings which have occurred in a time period closest to the image acquisition. When there are such events or happenings, the image acquired before or after the date in which events or happenings have occurred, is searched, and the specific image can be found.

Further, according to the present embodiment, the following service can be conducted. In the case where a specific image is confirmed, when this is displayed on the first display apparatus 21, the data relating to the date and the content is transmitted to the external server 23, and the information relating to the events or happenings which have occurred before and after the date, or the information relating to the events or happenings relating to the content is displayed on the second display apparatus 22. The operator can conduct the image composition processing such as the addition of characters, on the image displayed on the first display apparatus 21, by using these events or happenings.

In this connection, the image data and the information relating to the image data necessary for the search are stored in the writable media, and these can be read from the media reading apparatus 21b as the local storage apparatus onto the first display apparatus 21 at need.

Further, in the first display apparatus 21 mainly displaying the image content, when the image information stored in the external server 23 is displayed according to the image content and the switch information stored in the media reading apparatus 21b, because the image information is automatically displayed, it is preferable.

Further, it is preferable when the information displayed on the second display apparatus 22 includes the information relating to any one of a notice, advertisement, the image at the time near the photographing date of the image, and landscape or accident image near the image content, or a combination of them.

Further, when the display of the information stored in the external server 23 is inhibited according to the switch information stored in the local storage apparatus 21b, because the transmission of the unnecessary information is prevented, it is preferable.

Further, when the information to be used for time-ranking the image displayed on the first display apparatus 21 is displayed on the second display apparatus 22, the search can be more easily conducted, which is convenient.

Further, although it is considered that the personal computer is used as the first display apparatus 21, when the first display apparatus is a television connected with the domestic game machine, because it exists in almost family, the economical burden of the user can be suppressed in the case where the image searching and viewing system of the present embodiment is used.

Further, referring to FIG. 3, a service system which receives the data processing service through the network, by using the first display apparatus 21 as a terminal equipment connected to the network, and the outside server 23, will be described below. Because a unique ID cord is stored in the media M which can be read out by the media reading apparatus 21b as the local storage apparatus connectable to the first display apparatus 21, and the ID cord is transmitted corresponding to the use of the service of the user, such as, for example, the print order from the first display apparatus 21, and the account information corresponding to the ID cord in the external server is changed, even when the user forgets the ID cord, or even when the user receives the data processing service by using another terminal equipment, because, by connecting the media reading apparatus 21b to the first display apparatus 21, the ID cord unique to the user is transmitted to the external server 23, and the account information is automatically rewritten, the trouble of operation is saved, and it is convenient.

Further, it is also considered that the data processing software is not presented in the form of, for example, the CD-ROM, but presented by being downloaded through the network.

When referring to FIG. 1, the user can store the software for the data processing (it may be the game software) in a hard disk (not shown) which is a local storage medium, by downloading the software from the download center (not shown) through the network such as the internet through the interface 19, by using the data processing apparatus 10. Every time of the download, a predetermined account is loaded online, and for example, a corresponding amount of money is paid from a user's account.

The user can conduct the view, search, processing, and print of the image in the data base by using the downloaded software and the image data and the data necessary for the search, stored in the media M. In this manner, when the image data and the data necessary for the search are stored in the same storage disk, the data processing can be effectively conducted. Further, the image data can be used in common independently form the upgrade of the software.

Further, as a modified example, it is also considered that the user purchases the CD-ROM having the function to make access to the download center through the internet. When the CD-ROM is started by the data processing apparatus 10, the identification symbol proper to the CD-ROM is used as the pass word, and by making access to the download center through the internet, the desired software is downloaded, and can be stored in the local storage medium (hard disk).

In such the case, the accounting may be conducted online, or the CD-ROM itself corresponds to the software, and may be priced by a price corresponding to the price of the software to be downloaded. Alternatively, the form of use such as the pre-paid card is also considered, in which the account and the residual money information of the person are arranged by the download center, and the account is subtracted from the amount of money paid when the CD-ROM is purchased. In this case, it is necessary to set the personal pass word other than the identification symbol proper to the CD-ROM.

According to such the form of use, it can correspond to even a case where the price of the CD-ROM is different depending on the price of the software, and further, because the personal information does not leak as in the online transaction, it is considered that the security is high. Further, when it is used as the prepaid card, because the upper limit of the prepaid amount of money is determined, there is also an advantage that there is no anxiety to excessively use.

As described above, the present invention is described referring to the embodiment, however, the present invention should not be considered by being limited to the above embodiment, but, it is of course that the present invention can be appropriately modified and improved.

According to the present invention, by conducting the data processing such as the searching and viewing of the image according to the stored image data in the more easily usable form, the data processing system and the image searching and viewing system by which the operability of the user is increased, can be provided.

What is claimed is:

1. A data processing system, comprising:
a software having a function to process data;
a storage medium storing image data and data needed for retrieving; and
a processor to access both of the software and the storage medium so as to conduct processing the data in the storage medium based on the software.

2. A data processing system, comprising:
a first storage medium storing information needed for obtaining a software having a function to process data;
a second storage medium storing image data and data needed for retrieving; and
a processor to access both of the first storage medium and the second storage medium so as to conduct processing the image data in the second storage medium based on the software obtained through the information in the first storage medium.

3. The data processing system of claim 2, wherein the information in the first storage medium includes URL in a download center and identification information of the first storage medium.

4. The data processing system of claim 2, wherein the processor downloads the software into one of the first storage medium and the second storage medium or another storage medium through a network.

5. The data processing system of claim 2, wherein the first storage medium has a function to pay a rental fee of the software in advance.

6. The data processing system of claim 2, wherein a payment is charged by an on-line basis in accordance with a price of the software.

7. A data processing system, comprising:
a first storage medium storing a software having a function to process data;
a second storage medium storing image data; and
a processor to access both of the first storage medium and the second storage medium so as to conduct processing the image data in the second storage medium based on the software in the first storage medium.

8. The data processing system of claim 7, wherein the software has a function to conduct registering, viewing, retrieving, processing, printing and making a print order through an internet for the image data stored in the second storage medium and the second storage medium stores data needed for retrieving.

9. The data processing system of claim 8, wherein the second storage medium is writable and the first storage medium is read-only.

10. The data processing system of claim 8, wherein when the image data and the data needed for retrieving are written in the second storage medium, the image data are written after the data needed for retrieving are written.

11. The data processing system of claim 8, wherein the second storage medium comprises a plurality of second storage sub-media and the image data and the data needed for retrieving are stored in the plurality of second storage sub-medium sequentially from a former second storage sub-media to a latter second storage sub-medium, and wherein the latter second storage sub-medium stores thumbnail data of the image data and the data needed for retrieving which are stored in the former second storage sub-medium.

12. The data processing system of claim 11, wherein when only the latter second storage sub-medium is used to conduct processing original image data stored in the former second storage sub-medium, the processing is conducted by using the thumbnail data.

13. A data processing system, comprising:
a read-only storage medium storing a first protection key;
a writable storage medium storing at least image data; and
a processor to access both of the read-only storage medium and the writable storage medium so as to conduct processing the image data.

14. The data processing system of claim 13, wherein both of the read-only storage medium and the writable storage medium store a second protection key having a correlation to both the read-only storage medium and the writable storage medium.

15. The data processing system of claim 13, wherein the read-only storage medium stores global service information and the writable storage medium stores local service information.

16. The data processing system of claim 13, wherein the first protection key is stored at an exclusive place in the non-writable storage medium where only a specific data processing apparatus can conduct reading or writing.

17. The data processing system of claim 14, wherein the second protection key is stored at an exclusive place in the writable storage medium where only a specific data processing apparatus can conduct reading or writing.

18. The data processing system of claim 14, wherein at least one of the first protection key and the second protection key is stored at an exclusive place where only a specific data processing apparatus possible can conduct reading or writing.

19. The data processing system of claim 13, wherein an executing file is stored only in the read-only storage medium.

20. A storage medium for use in the data processing system of claim 1.

21. A image processing service for use in the data processing system of claim 1.

22. An image retrieving viewing system, comprising:
a first display to indicate mainly image content;
a second display to indicate mainly information regarding the image content; and
an external server being connected with the first display and the second display,
wherein the information indicated on the second display is changed in response to an operation for the first display.

23. The image retrieving viewing system of claim 22, wherein the image content is indicated on the first display based on image data stored in a local storage device connected to the first display.

24. The image retrieving viewing system of claim 23, wherein the first display indicates image information stored in the external server based on the image content and switch information stored in the local storage device.

25. The image retrieving viewing system of claim 24, wherein the image information includes either an announcement, an advertisement, an image at a time of photographing, an image of a view similar to the image content or an image of an event or information regarding a combination of the images.

26. The image retrieving viewing system of claim 23, wherein indication of the information stored in the external server is prohibited based on the switch information stored in the local storage device.

27. The image retrieving viewing system of claim 22, wherein the second display indicates information used to put a rank in terms of time to an image indicated on the first display.

28. The image retrieving viewing system of claim 22, wherein the first display is a television.

29. A service system to provide data processing service through a network, comprising:
a terminal connected to the network; and
an external server,
wherein the service system stores a unique ID code in a local storage device capable of being connected to the terminal, transmits the ID code in accordance with a use of the service by a client and changes payment charging information corresponding to the ID code in the external server.
